(19) United States
(12) Patent Application Publication
(10) Pub. No.: US 2024/0383334 A1
(43) Pub. Date: Nov. 21, 2024

(54) COMPUTER-IMPLEMENTED METHOD FOR CONTROLLING A SYSTEM FOR PLAYING MUSIC IN A MOTOR VEHICLE

(71) Applicant: Dr. Ing. h. c. F. Porsche AG, Stuttgart (DE)

(72) Inventor: Norman Friedenberger, Berlin (DE)

(21) Appl. No.: 18/663,683

(22) Filed: May 14, 2024

(30) Foreign Application Priority Data
May 17, 2023 (DE) 10 2023 113 063.3

(51) Int. Cl. B60K 35/26; H02J 7/00

(52) U.S. Cl. CPC B60K 35/26; H02J 7/0048

(57) ABSTRACT

A computer-implemented method is provided for controlling a system for playing music in a motor vehicle. The method includes determining a state of charge of a traction battery of the motor vehicle (S1); and playing the music (S2) so that a nature of the play-back is dependent on the state of charge.

### CROSS-REFERENCE TO RELATED APPLICATION

This application claims priority on German Patent Application No 10 2023 113 063.3 filed May 17, 2023, the entire disclosure of which is incorporated herein by reference.

### BACKGROUND

Field of the Invention. The invention relates to a computer-implemented method for controlling a system for playing music in an automotive vehicle.

Related Art Playing music in a motor vehicle can make the stay in the motor vehicle more comfortable. The music may be generated from data stored a storage medium, from a wirelessly received data stream, or from radio waves.

US 2022/072962 A1 discloses a motor vehicle that which switches off the music play-back system in accordance with the state of charge of the traction battery.

In contrast, an object of the invention is to provide an apparatus, a motor vehicle and a method to give the driver with more detailed information about the state of charge of the traction battery.

### SUMMARY OF THE INVENTION

One aspect of the invention relates to a method for determining a state of charge of a traction battery of a motor vehicle. In the context of this description, a traction battery is understood to mean a rechargeable battery that supplies electrical energy to a drive system of the motor vehicle. The drive system then drives the motor vehicle. For example, the state of charge may be indicated or measured in Ah. Alternatively, the state of charge may be indicated or measured as a percentage of a capacity of the traction battery. For example, the capacity may be the nominal capacity. The higher the state of charge, the more energy is contained in the traction battery. It is also possible to specify or determine the state of charge as a range. The range is understood to mean a distance that the motor vehicle can still traverse at the current state of the battery.

The music is played in a manner that is dependent on the state of charge. In this way, a user can enjoy selected music while being informed of the state of charge of the traction battery at the same time. The user also can observe traffic at the same time. The musical enjoyment is not interrupted or drowned out by an announcement regarding the state of charge of the traction battery.

For example, the nature of the play-back may relate to emphasizing specific frequencies. For example, the higher the state of charge, the more strongly low-frequency sounds can be emphasized during the playing of the music.

According to one embodiment, the nature of the play-back may involve dynamics of the music. In the context of this description, the dynamics is understood as a volume range. For example, at a high dynamics level, there are big differences between loud and quiet sounds of the music. At a low dynamics level, these differences are less.

According to one embodiment of the invention, the music may be played at a higher dynamics level at a first state of charge than at a second state of charge. The first state of charge may be higher than the second state of charge in this embodiment.

In some embodiments, at a high dynamics level, more elements of the music may be audible to a human ear than at a low dynamics level. For example, the human ear may be a healthy ear of a healthy person under the age of 50.

According to some embodiments, the nature of the play-back may be adjusted continuously according to the state of charge. In particular, the nature of the play-back may be adjusted continuously.

In some embodiments, the nature of the play-back may be adjusted in steps according to the state of charge.

Another aspect of the invention relates to an apparatus that comprises a digital electronic signal processing means and a digital electronic data memory. Instructions are stored in the data memory. The signal processing means is configured to read out and execute the instructions. The instructions are configured to cause the signal processing means to carry out a method according to an embodiment of the invention.

The motor vehicle comprises an electric drive system, a traction battery, a system for playing music, and an apparatus as described herein. The traction battery is designed to supply electrical energy to the electric drive system.

Further features and advantages of the invention become apparent from the following description of a preferred embodiment with reference to the drawing.

### BRIEF DESCRIPTION OF THE DRAWING

FIG. 1 a schematic view of a method according to one embodiment of the invention.

FIG. 2 is a schematic view of an automotive vehicle in accordance with the invention.

### DETAILED DESCRIPTION

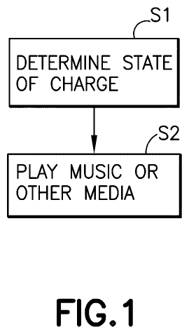

Step S1 of the method shown in FIG. 1 includes determining a state of charge of a traction battery of a motor vehicle. For example, the state of charge may be measured. Step S2 includes playing music, news or other media content. In so doing, a nature of the play-back depends on the state of charge determined in step S1.

For example, the nature of the play-back may include emphasizing certain frequency ranges. It is also possible that the nature of the play-back involves a dynamics level of the music such that at a higher state of charge, for example, more elements of the music are audible than at a lower state of charge.

Thus, the nature of the play-back informs a user of the state of charge of the traction battery without interrupting or drowning out the music or requiring them to look at a display. This represents a new experience for the user. This type of new experience may be of particular interest, in particular to technology-oriented users.

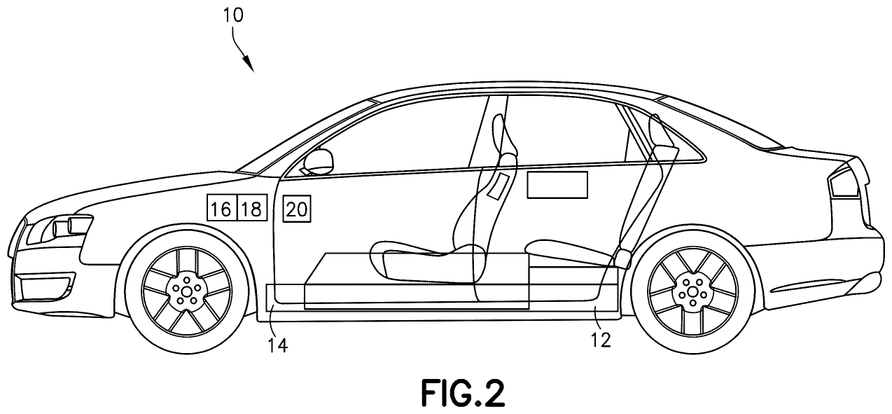

FIG. 2 shows a motor vehicle 10 in accordance with an embodiment of the invention. The motor vehicle 10 has a rechargeable traction battery 12 and a drive system 14. The traction battery 12 supplies electrical energy to the drive system 14 of the motor vehicle 10. The drive system 14 includes at least one electric machine that drives the motor vehicle 10. The motor vehicle 10 also has a digital electronic signal processing means or control unit 16 and a digital electronic data memory 18. Instructions are stored in the memory 18, and the control unit 16 is configured to read out and execute the stored instructions. The instructions are configured to cause the control unit 16 to monitor the traction battery 12, to operate the drive system 14 and to perform other control functions, as explained herein.

The control unit 16 may be understood in connection with this disclosure to mean a machine or electronic circuitry or a high-performance computer, for example. In particular, the control unit 16 may be a master processor (central processing unit (CPU)), a microprocessor, or a microcontroller, for example an application-specific integrated circuit or a digital signal processor, optionally in combination with the memory 18 for storing program instructions. The control unit 16 may also be a virtualized processor, a virtual machine, or a soft CPU. For example, the control unit 16 may also be a programmable processor equipped with configuration steps for carrying out the method described herein or configured with configuration steps in such a way that the programmable processor realizes the features of the method and system described herein. In addition, highly parallel computing units and high-performance graphics modules may be provided. The memory 18 may, for example, be understood in connection with this disclosure to mean a non-volatile memory in the form of a flash memory (Flash EEPROM) or a permanent memory, such as a hard drive.

Monitoring the traction battery 12 by the control unit 16 includes monitoring the state of charge (SOC) of the traction battery 12, as is known in electric vehicles, so that the driver knows the remaining driving range. For example, the state of charge may be indicated or measured in Ah. Alternatively, the state of charge may be indicated or measured as a percentage of a capacity of the traction battery 12. The higher the state of charge, the more energy is contained in the traction battery 12. It is also possible to specify or determine the state of charge as a range. The range is understood to mean a distance that the motor vehicle 10 can still traverse at the current state of the traction battery 12.

The motor vehicle 10 also has an entertainment system 20 that is operative to play music, news or other acoustic media. Music, for example, may be generated from data stored the digital electronic data memory 18, from a wirelessly received data stream, or from radio waves.

The music is played by the entertainment system 20 in a manner that is dependent on the state of charge of the traction battery 12 as determined by the control unit 16. In this way, a user can enjoy selected music while simultaneously being informed of the state of charge of the traction battery 12. The user also is not distracted by dashboard display to check the state of charge, and therefore can observe traffic and simultaneously be aware of the state of charge. The musical enjoyment is not interrupted or drowned out by an announcement regarding the state of charge of the traction battery 12.

For example, the nature of the play-back by the entertainment system 20 may be altered by the control unit 16 to emphasize specific frequencies. For example, the higher the state of charge, the more strongly low-frequency sounds can be emphasized during the playing of the music. The nature of the play-back by the entertainment system may affect the dynamics of the music. In this context, the dynamics is understood as a volume range. For example, at a high dynamics level, there are big differences between loud and quiet sounds of the music. At a low dynamics level, these differences are less. Music may be played at a higher dynamics level at a first state of charge than at a second state of charge. For example, at a high dynamics level, the control unit 16 may cause more elements of the music to be audible to a human ear than at a low dynamics level. The nature of the play-back may be adjusted continuously according to the state of charge, or the nature of the play-back may be adjusted in steps according to the state of charge.

1. A computer-implemented method for controlling a system for playing music in a motor vehicle, comprising the steps of:
determining a state of charge of a traction battery of the motor vehicle; and
playing the music in a manner so that a nature of a play-back is dependent on the state of charge.

2. The method of claim 1, the nature of the play-back comprises a dynamics level of the music.

3. The method of claim 2, playing the music comprises playing the music at a higher dynamics level at a first state of charge than at a second state of charge, wherein the first state of charge is higher than the second state of charge.

4. The method of claim 3, wherein the high dynamics level provides more music that is audible to a human ear than a low dynamics level.

5. The method of claim 1, wherein playing the music comprises continuously adjusting the nature of the play-back according to the state of charge.

6. The method of claim 1, characterized in that the nature of the play-back is adjusted in steps according to the state of charge.

7. An apparatus for controlling a system for playing music in a motor vehicle, wherein the apparatus comprises a digital electronic signal processor and a digital electronic data memory that stores instructions, and the signal processor is configured to read out and execute the instructions, the instructions being configured to cause the signal processing means to determine a state of charge of a traction battery of the motor vehicle; and to play the music in a manner such that a nature of a play-back is dependent on the state of charge.

8. A motor vehicle comprising an electric drive system, a traction battery, a system for playing music, and the apparatus of claim 7, wherein the battery is designed to supply electrical energy to the electrical drive system.
